(19) United States
(12) Patent Application Publication
(10) Pub. No.: US 2025/0065187 A1
(43) Pub. Date: Feb. 27, 2025

(54) STRETCHING MACHINE

(71) Applicant: Mountain Men LLC, Kennewick, WA (US)

(72) Inventors: Kenneth Egli, Kennewick, WA (US); Jason Gilbert, Kennewick, WA (US)

(73) Assignee: Mountain Men LLC, Kennewick, WA (US)

(21) Appl. No.: 18/811,450

(22) Filed: Aug. 21, 2024

Related U.S. Application Data
(60) Provisional application No. 63/520,878, filed on Aug. 21, 2023.

(51) Int. Cl. A63B 23/04; A63B 23/00; A63B 24/00

(52) U.S. Cl. CPC A63B 23/04; A63B 24/0087; A63B 2023/006; A63B 2208/0252

(57) ABSTRACT

A system and device for assisting users with stretching exercises comprised of a base, at least one stretch-assistance armature further comprised of at least one pylon, at least one motor, and at least one fastening means.

### PRIORITY CLAIM

This application claims priority to and/or the benefit of U.S. provisional patent application Ser. No. 63/520,878 filed Aug. 21, 2023. The foregoing application is incorporated by reference in its entirety as if fully set forth herein.

### FIELD OF THE INVENTION

The invention herein comprises a system, device, and method for assisting users, such as, but not limited to, medical patients, with stretching and physical therapy. This particular invention can also be implemented in a variety of other fields within medicine, such as in the veterinary field, or in fields outside the medical field where machine-assisted movement is beneficial.

### SUMMARY

The invention herein comprises a system, device, and method for assisting users, such as, but not limited to, medical patients, with stretching and physical therapy. This particular invention can also be implemented in a variety of other fields within medicine, such as in the veterinary field, or in fields outside the medical field where machine-assisted movement is beneficial. Specific details of certain embodiments of the invention are set forth in the following description and in the figures to provide a thorough understanding of such embodiments. The present invention may have additional embodiments, may be practiced without one or more of the details described for any particular described embodiment, or may have any detail described for one particular embodiment practiced with any other detail described for another embodiment.

As used herein and unless otherwise indicated, the terms “a” and “an” are taken to mean “one”, “at least one” or “one or more”. Unless otherwise required by context, singular terms used herein shall include pluralities and plural terms shall include the singular.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

The present invention is comprised of a base with one or more stretch-assistance armatures extending therefrom. The stretch-assistance armatures may be comprised of one or more motorized joints and a user securing fastening or user-support such as, but not limited to, a foot pedal or stirrup, and in some embodiments may be further comprised of one or more straps or other locking devices configured to removably couple one or more portions of a user's extremities to the stretch-assistance armatures. For example, such fasteners might be comprised of a length of material, flexible or not, configured to wrap around a user's extremities such as a leg or arm, and help fasten them to the stretch-assistance armature. Such fasteners may be located on the base or anywhere on the stretch-assistance armatures. The present invention, in some embodiments, is thus configured to assist a user in performing one or more stretching exercises and can be utilized by individuals with mobility limitations or other needs. In some embodiments, the stretch-assistance armatures are configured to be limited in the force they can exert on the user for safety reasons; functioning to assist with movements but without enough potential force that a user might become injured by the stretch-assistance armatures trying to stretch a user too far.

In some embodiments the base of the present invention may be further comprised of one or more flexible panels which may be positioned at a point on the base where the buttocks of a user are intended to be positioned, with such flexible panels being configured to pivot in one or more directions in response to instruction from a control device in order to assist the user with moving their hips and/or legs. In other embodiments, the invention may also be comprised of flexible panels positioned at the location of the user's shoulders, or at various points along the back and/or spine to aid in stretching those regions. The invention may, depending on the embodiment, incorporate sub-panels within an individual flexible panel, and/or be comprised of a flexible material such that the face of the panel can be deformed from flat to contour to requested shapes, such as a user's body. In embodiments wherein the flexible panels are comprised of one or more sub-panels, the individual sub-panels may be configured with their own actuation, permitting individual movement and articulation. Depending on the embodiment, the panels may be connected to the base through one or more motors and one or more actuators, allowing the panel to rotate and move in a variety of different directions or even elevate to more naturally support a user. Depending on the embodiment, the flexible panels may be more rigid or flexible, and may be able to contort or conform to a user's body; they may further be comprised of a ductile material, or variety of materials with flexible and/or ductile properties capable of deforming relative to the contour of a user's body.

In other embodiments, the flexible panels may be more numerous but individually small, resulting in a similar function to the sub-panels. Some embodiments of the invention may involve a base that is split into a number of sub-bases functioning in substantially similar of a role. Depending on the embodiment, the panels may instead be a series of smaller individual panels able to move individually as a unit, such that, for example, each could elevate slightly relative to the others to create a contoured surface comprised of smaller squares (or similar shapes). Other variants of the invention may utilize rounded spheres at the end of elevatable pistons to achieve a similar effect.

In some embodiments, the base component may take on a variety of shapes, such as a substantially flat surface, but in other embodiments it may be padded or contoured depending on the specific needs of the embodiment. In some configurations, the base may be of a variety of overall shapes, such as substantially rectangular, circular, or an irregular polygonal shape. In other embodiments, the shape may be asymmetrical or symmetrical if such is desired for the embodiment. Other embodiments of the invention may feature a base component that approximates the shape of a human body or portion thereof.

In some embodiments, the base component may be further comprised of one or more cushions, which may be utilized to support various portions of a user's body. For example, though not exhaustive, the base may be comprised of a cushion positioned and/or shaped to support a user's neck and head while they lie on the base to use the invention, or one to support the lower back. The cushion(s) may be contoured or otherwise configured to support such user. In some embodiments, the cushions may be attached to the panels and thus can be moved and otherwise utilized in the same manner as described in the foregoing paragraphs regarding the panels. In some embodiments, the base itself may be a ductile or cushioned material, and in some embodiments the base may be contoured to substantially accommodate a human lying on their back. The cushions of the base may be located in a variety of places to support the user.

The stretch-assistance armatures may be configured in a variety of ways depending on the needs of a given embodiment. In some embodiments they may be comprised of one or more motorized joints capable of rotating at least part of the length of the stretch-assistance armature (or pylons comprising it) in at least one direction. Some embodiments may feature motorized joints configured to rotate in multiple directions, or a joint may be comprised of multiple motors to enable additional planes of motion. The stretch-assistance armatures, in some embodiments and variants, may feature components configured to help secure a user's extremities thereto in the form of a user-support or user-securing fastening, such as, but not limited to, straps, handles, cuffs, pedals, stirrups, or other forms of securing means. Depending on the embodiment, these may be secured anywhere from extremely loosely or not at all such that they merely guide a user's extremities, all the way to extremely firmly to the user thereby essentially requiring that their extremities move with the stretch-assistance armatures. Some embodiments may incorporate features such as pylons, hooks, or flanges which extend from the stretch-assistance armatures and function to assist in guiding a user's extremities. In some embodiments, the stretch-assistance armatures may end in a pedal or stirrup component configured to at least partially assist the user in keeping a foot in contact with the stretch-assistance arm; such component may be comprised of, but is not limited to, a flat surface, a pylon, stirrup, and may be further configured with a cuff or similar component to aid in securing the user's foot, or in some embodiments, a hand, wrist, or other portion of the body. In some embodiments, the stretch-assistance armatures are comprised of a series of pylons connected to motors in a chain, with each pylon leading to a motor, and a new pylon leading from said motor to another, until it reaches an end. In some embodiments, the motors and pylons are configured to substantially conform to the length of a person's leg and the motors are located at a person's joints; depending on the embodiment the pylons may be configured to be adjustable in length. For example, some pylons may be telescopic, pistons, and/or comprised of smaller joined rods that can be extended. In others, the pylons may be substantially straight, while in others they may be curved, or capable of being deformed, depending on the nature of the embodiment. In further embodiments, the motors and pylons may instead be positioned to substantially conform to the length of a person's arms, or also their legs. Some embodiments of the invention may feature pylons that are adjustable in length to accommodate a variety of users, or may involve modular stretch-assistance arms that can be swapped in and out for different users or stretches.

The motor components, depending on the needs of a given embodiment of the invention, may be of a variety of different motor methods, such as, but not limited to, electronic, magnetic, pneumatic, hydraulic, or manual motors, or may be hybrids thereof. The invention may also function with yet-to-be developed motor methods, provided they are capable of rotating the pylons of the stretch-assistance armatures. In some embodiments, multiple varieties of motors may be used to provide alternative or back-up forms of rotational motion, while in other embodiments it may be preferable to use different motors depending on where the motor is located on the stretch-assistance armature, or which user limb is being stretched. In some embodiments, the motor should be configured to allow for rotational actuation in at least one plane, though in other embodiments additional planes of motion may be preferred. Accordingly, the motors may also be activated independently, and various activities may involve extremities doing different motions from each other at the same time.

In some embodiments, the stretch-assistance armatures may be further comprised of one or more actuators configured to provide linear motion to the pylon component of the stretch-assistance armatures, extending their length as a user stretches to be in-line with the extension of a user's extremities. For example, as a user stretches their leg, the distance between the user's ankle and knee may increase due to extension of the joints therein, requiring that the pylon of the stretch-assistance armature do the same in order to provide adequate assistance. In such cases, an actuator may be employed to facilitate and assist such motion. In other embodiments, the pylons themselves may be comprised of springs, or may be inherently partially extensible, in order to provide for the foregoing described extension. Similarly, where compression of the pylons is needed, the same foregoing features can permit for such compression. Depending on the embodiment, the stretching routines in the computer memory, if utilized, may provide for stretches where the device assists a user in stretching limbs by applying an extension force at the securing means of the user's limbs. In other embodiments, the pylons may be pistons, telescopic, comprised of smaller connected rods that extend to reach a greater length, and/or may be partially retractable into the armature and/or motors.

The present invention may be further comprised of a computer processor component which may be further comprised of or otherwise coupled to a computer memory wherein the computer processor is configured to perform tasks based on instructions saved in the computer memory when certain commands are put into the device based on instructions from a user or based on a pre-programmed schedule. Some embodiments of the invention may be further comprised of a user input device, potentially a control terminal or control unit, configured to receive commands from a user using a mechanism such as, but not limited to, a button, keypad, dial, switch, or similar means of permitting the user to communicate instructions with the device. The user input may be directly connected to the device or may be connected via a wireless network or similar wireless means. Some embodiments of the invention may be further comprised of a microphone or similar sound detection sensor configured to detect oral commands from the user and route those commands to the computer processor to instruct the rest of the device. For some embodiments of the invention, the user may be able to use a separate input device, such as a software application installed on a smartphone, that communicates through a wire and/or wirelessly over a network with the computer process component wherein the computer processor component is further comprised of a network connection device that may include a wireless receiver.

Depending on the embodiment, the control unit may be further comprised of a screen or other form of output, such as lights, a display, touchscreen, or a plurality thereof, in order for the system to provide the user with information and feedback, and to facilitate the selection of stretching exercises.

Depending on the embodiment used, the computer memory may store instructions for the computer processor to process such as, but not limited to, programmed stretching routines or programs to have the stretching-assistance armatures and/or flexible panels guide a user through, wherein when the user requests a particular routine or program the computer processor instructs the flexible panels and/or motors of the stretching-assistance armatures to move in specific, pre-programmed motions and guide a user through them. The computer memory may also store instructions on specific motions, thus permitting a user to request the computer processor have the flexible panels and/or stretching-assistance armatures perform various actions such as, but not limited to, assisting with stretching a user's leg or knee, or such other extremities as needed. In addition, some embodiments may involve the stretching-assistance armatures moving at different speeds in order to simulate different motions. Some programs within the computer memory may simulate certain activities, such as, but not limited to, walking or running. Some embodiments may involve programs of movements that involve going through a pre-set, or individually selected, series of movements with a user.

The system may also be configured to provide variable amounts of force, or in some cases the system may provide both force and support, or support only. In such embodiments, the system's support may take the form of holding positions that the user moves their extremities to, thus, by way of example, preventing a user's leg from falling if they overexert said leg; in such situations the system may slow the descent of the leg (or otherwise resist motion enough to cradle or otherwise mitigate a fall or similar potential harm) and/or may hold a stationary position based on the user's last movement and/or the program and assist with holding the leg in position. The system may determine how much force is being used through sensors located in the device, such as in the motorized joints of the stretch-assistance armatures or within the armatures themselves. Such sensors may be configured to detect resistance by a user to motion, the amount of force the user is applying, or the amount of force being applied to a user, and that information may be used by the system.

In some embodiments, the invention may be further comprised of mechanical, electronic, or digital inhibiting systems configured to prevent the stretch-assistance armatures and/or flexible panels from exceeding certain amounts of rotation or bending. Such features could help prevent injury to users that may result from a malfunction of the motors, or simply to ensure that a user cannot inadvertently injure themselves. In some embodiments, such inhibiting systems may also limit the amount of force the motors and/or flexible panels are able to exert at a given time, which may have a variety of beneficial effects, including, but not limited to, preventing injury to a user if there is a malfunction with the device or improper use thereof. The computer processor may also be programmed with certain safety protocols to ensure the device cannot injure a user, such as, but not limited to, restrictions on how much force the motors can engage and/or stopping the motors if they encounter a certain level of resistance. Such safety measures may also be intrinsically designed into the motors themselves, for some embodiments of the invention. Detection of the factors applicable may be accomplished, in some embodiments, through the integrated sensors.

Various embodiments of the invention may be powered in a multitude of ways; some may possess an integrated power supply while others may be powered externally by plugging into a wall outlet or similar source of consistent power. Depending on the embodiment, they may be powered by both an internal source, such as a battery, and an external source, such as a wire to a power grid.

### BRIEF DESCRIPTION OF THE DRAWINGS

Embodiments of the present invention are described in detail below with reference to the following drawings:

FIG. 1 is a perspective view of a stretching machine, in accordance with an embodiment of the invention;

FIG. 2 is a top view of a stretching machine, in accordance with an embodiment of the invention;

FIG. 3 is a bottom view of a stretching machine, in accordance with an embodiment of the invention;

FIG. 4 is a side view of a stretching machine, in accordance with an embodiment of the invention;

FIG. 5 is a front view of a stretching machine, in accordance with an embodiment of the invention;

FIG. 6 is a perspective view of a stretching machine demonstrating the flexible panels in operation, in accordance with an embodiment of the invention;

FIG. 7 is a perspective view of a stretching machine showing two stages of operation, in accordance with an embodiment of the invention;

FIG. 8 is a perspective view of a stretching machine showing three stages of operation, in accordance with an embodiment of the invention;

FIG. 9 is a rear view of a stretching machine showing the motion of flexible panels, in accordance with an embodiment of the invention; and

FIG. 10 is a system diagram showing the interaction between the control unit and the rest of the features of the invention, in accordance with an embodiment of the invention.

### DETAILED DESCRIPTION

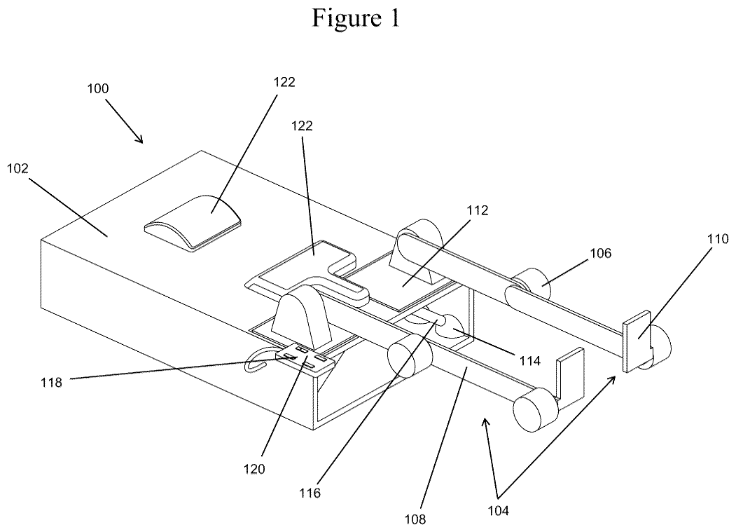

FIG. 1 is a perspective view of a stretching machine, in accordance with an embodiment of the invention. In some embodiments the device to aid in stretching 100 is comprised of: a base 102; and one or more stretch-assistance armatures 104 extending from the base 102 wherein the one or more stretch-assistance armatures 104 are comprised of one or more motorized joints 106, one or more pylons 108, and one or more user-securing fastenings 110. Depending on the embodiment, the base 102 may also be comprised of one or more flexible panels 112 located proximate to an end of the base 102 where such panels may be connected to the base via panel motors 114 and/or panel actuators 116 configured to allow them to rotate and/or translate in at least one direction. Depending on the embodiment, the device 100 may be further comprised of control unit 118 which may be further comprised of a computer processor, computer memory, and/or control device 120 wherein the computer memory is configured to store one or more programs which may be stretching routines, and the computer processor is configured to control the stretch-assistance armatures to guide a user through such programs. The control device, which may be integrated into the base 102 and/or communicably coupled via a network, may be configured to permit a user to control the device 100. Depending on the embodiment, the base 102 may be further comprised of one or more cushions 122 to support a user that is utilizing the device.

The flexible panels 112, depending on the embodiment, may be mobilized through the use of one or more panel motors 114 and/or one or more panel actuators 116 wherein they may permit the flexible panels 112 to utilize a variety of motions. Similarly, depending on the embodiment, the one or more stretch-assistance armatures 104 may be attached to the base 102 or the flexible panels 112, and may be configured to move in a variety of ways through the use of actuators and/or motorized joints 106.

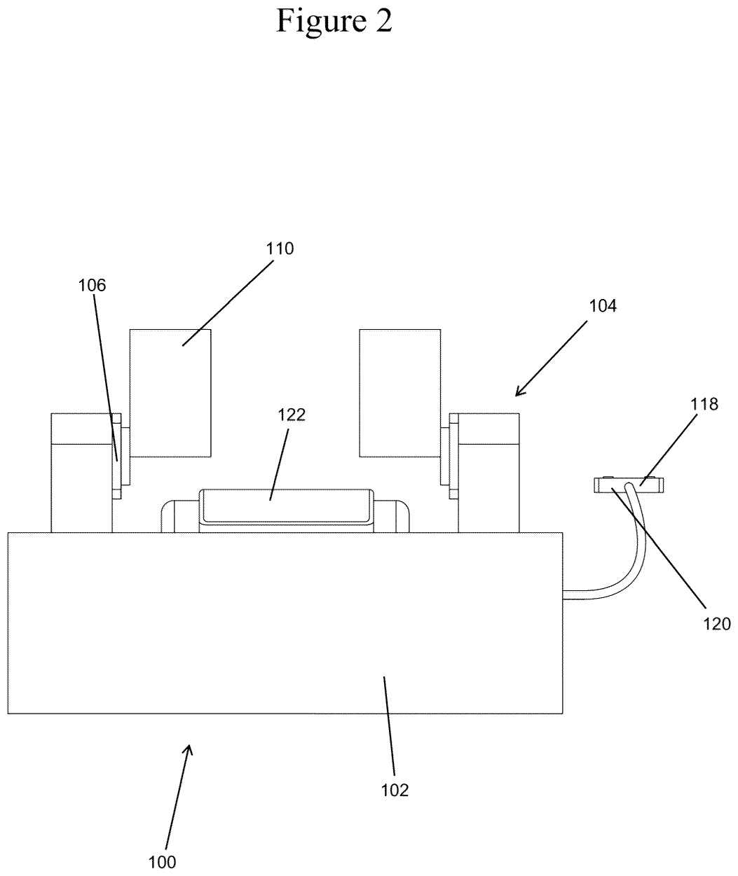

FIG. 2 is a top view of a stretching machine, in accordance with an embodiment of the invention. In some embodiments the device to aid in stretching 100 is comprised of: a base 102; and one or more stretch-assistance armatures 104 extending from the base 102 wherein the one or more stretch-assistance armatures 104 are comprised of one or more motorized joints 106, one or more pylons, and one or more user-securing fastenings 110. Depending on the embodiment, the base 102 may also be comprised of one or more flexible panels located proximate to an end of the base 102 where such panels may be connected to the base via panel motors and/or panel actuators configured to allow them to rotate and/or translate in at least one direction. Depending on the embodiment, the device 100 may be further comprised of control unit 118 which may be further comprised of a computer processor, computer memory, and/or control device 120 wherein the computer memory is configured to store one or more programs which may be stretching routines, and the computer processor is configured to control the stretch-assistance armatures to guide a user through such programs. The control device 120, which may be integrated into the base 102 and/or communicably coupled via a network, may be configured to permit a user to control the device 100. Depending on the embodiment, the base 102 may be further comprised of one or more cushions 122 to support a user that is utilizing the device.

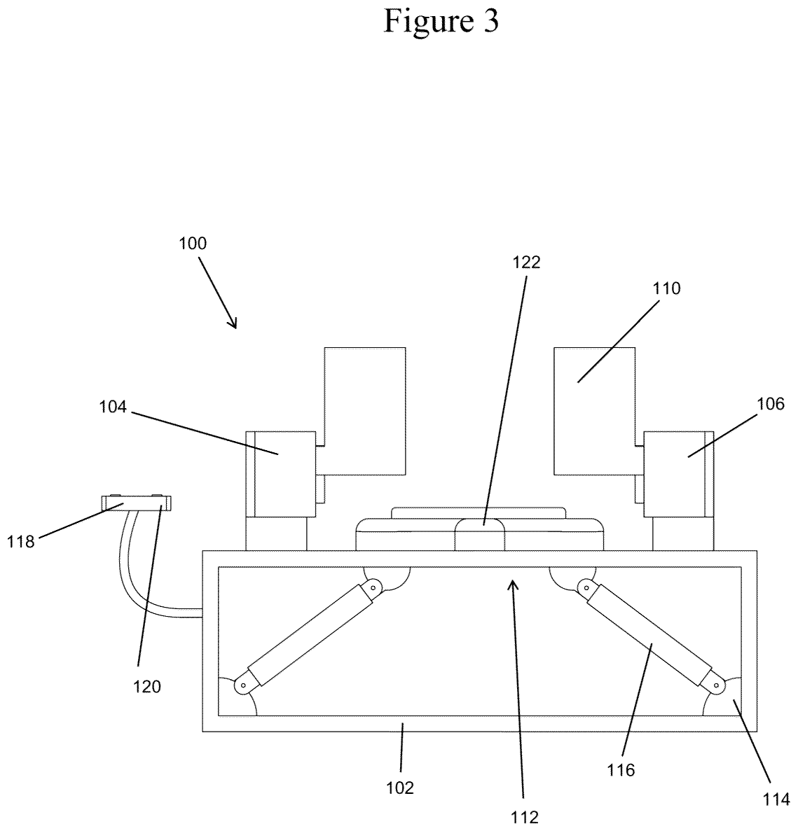

FIG. 3 is a bottom view of a stretching machine, in accordance with an embodiment of the invention. In some embodiments the device to aid in stretching 100 is comprised of: a base 102; and one or more stretch-assistance armatures 104 extending from the base 102 wherein the one or more stretch-assistance armatures 104 are comprised of one or more motorized joints 106, one or more pylons, and one or more user-securing fastenings 110. Depending on the embodiment, the base 102 may also be comprised of one or more flexible panels 112 located proximate to an end of the base 102 where such panels may be connected to the base via panel motors 114 and/or panel actuators 116 configured to allow them to rotate and/or translate in at least one direction. Depending on the embodiment, the device 100 may be further comprised of control unit 118 which may be further comprised of a computer processor, computer memory, and/or control device 120 wherein the computer memory is configured to store one or more programs which may be stretching routines, and the computer processor is configured to control the stretch-assistance armatures to guide a user through such programs. The control device 120, which may be integrated into the base 102 and/or communicably coupled via a network, may be configured to permit a user to control the device 100. Depending on the embodiment, the base 102 may be further comprised of one or more cushions 122 to support a user that is utilizing the device.

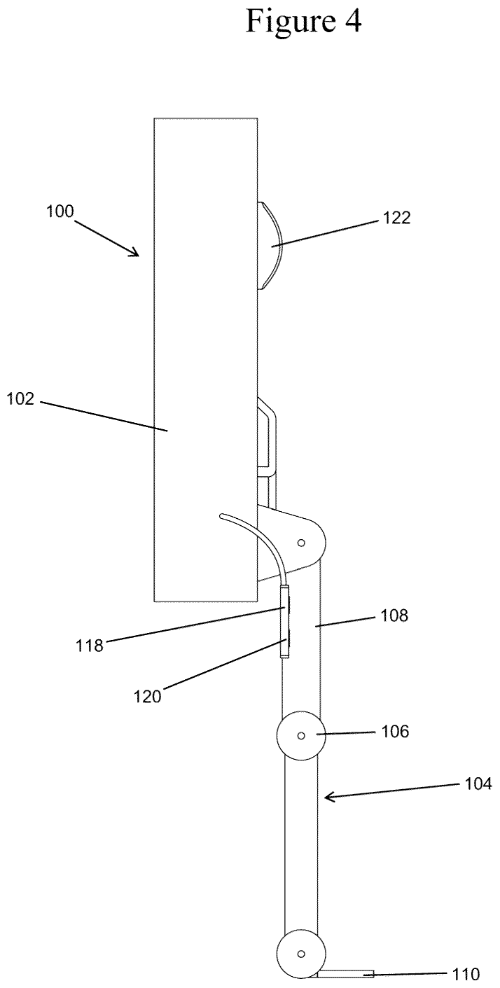

FIG. 4 is a side view of a stretching machine, in accordance with an embodiment of the invention. In some embodiments the device to aid in stretching 100 is comprised of: a base 102; and one or more stretch-assistance armatures 104 extending from the base 102 wherein the one or more stretch-assistance armatures 104 are comprised of one or more motorized joints 106, one or more pylons 108, and one or more user-securing fastenings 110. Depending on the embodiment, the base 102 may also be comprised of one or more flexible panels located proximate to an end of the base 102 where such panels may be connected to the base via panel motors and/or panel actuators configured to allow them to rotate and/or translate in at least one direction. Depending on the embodiment, the device 100 may be further comprised of control unit 118 which may be further comprised of a computer processor, computer memory, and/or control device 120 wherein the computer memory is configured to store one or more programs which may be stretching routines, and the computer processor is configured to control the stretch-assistance armatures to guide a user through such programs. The control device 120, which may be integrated into the base 102 and/or communicably coupled via a network, may be configured to permit a user to control the device 100. Depending on the embodiment, the base 102 may be further comprised of one or more cushions 122 to support a user that is utilizing the device.

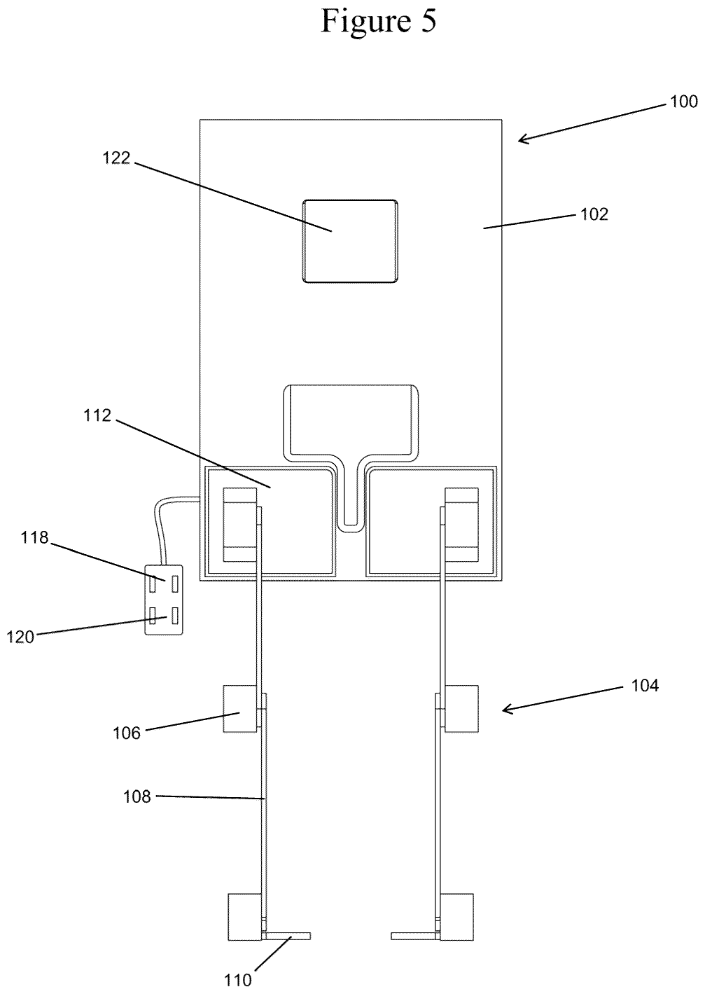

FIG. 5 is a front view of a stretching machine, in accordance with an embodiment of the invention. In some embodiments the device to aid in stretching 100 is comprised of: a base 102; and one or more stretch-assistance armatures 104 extending from the base 102 wherein the one or more stretch-assistance armatures 104 are comprised of one or more motorized joints 106, one or more pylons 108, and one or more user-securing fastenings 110. Depending on the embodiment, the base 102 may also be comprised of one or more flexible panels 112 located proximate to an end of the base 102 where such panels may be connected to the base via panel motors 114 and/or panel actuators 116 configured to allow them to rotate and/or translate in at least one direction. Depending on the embodiment, the device 100 may be further comprised of control unit 118 which may be further comprised of a computer processor, computer memory, and/or control device 120 wherein the computer memory is configured to store one or more programs which may be stretching routines, and the computer processor is configured to control the stretch-assistance armatures to guide a user through such programs. The control device 120, which may be integrated into the base 102 and/or communicably coupled via a network, may be configured to permit a user to control the device 100. Depending on the embodiment, the base 102 may be further comprised of one or more cushions 122 to support a user that is utilizing the device.

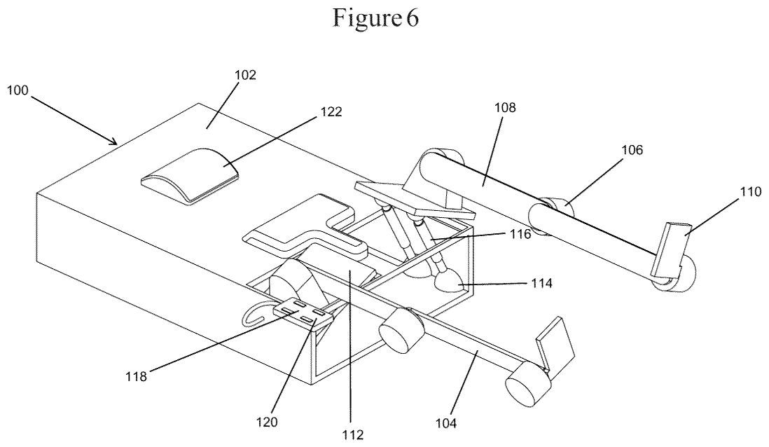

FIG. 6 is a perspective view of a stretching machine demonstrating the flexible panels 112 in operation. In some embodiments the device to aid in stretching 100 is comprised of: a base 102; and one or more stretch-assistance armatures 104 extending from the base 102 wherein the one or more stretch-assistance armatures 104 are comprised of one or more motorized joints 106, one or more pylons 108, and one or more user-securing fastenings 110. Depending on the embodiment, the base 102 may also be comprised of one or more flexible panels 112 located proximate to an end of the base 102 where such panels may be connected to the base via panel motors 114 and/or panel actuators 116 configured to allow them to rotate and/or translate in at least one direction. Depending on the embodiment, the device 100 may be further comprised of control unit 118 which may be further comprised of a computer processor, computer memory, and/or control device 120 wherein the computer memory is configured to store one or more programs which may be stretching routines, and the computer processor is configured to control the stretch-assistance armatures to guide a user through such programs. The control device 120, which may be integrated into the base 102 and/or communicably coupled via a network, may be configured to permit a user to control the device 100. Depending on the embodiment, the base 102 may be further comprised of one or more cushions 122 to support a user that is utilizing the device.

As demonstrated in FIG. 6; the flexible panels 112 may pivot through action of the one or more panel motors 114 and/or one or more panel actuators 116. For example, the one or more panel actuators 116 may extend thus pushing the flexible panels 112 up and outward, or they may retract causing the flexible panels to move inwards. Depending on the embodiment, the flexible panels 112 may be coupled to the base 102 by a hinge or similar mechanism that permits them to move without disconnecting from the base 102, or they may be configured to move independently of the base 102. In some embodiments, the one or more panel motors 114 may rotate the flexible panels 112 or one or more panel actuators 116 in order to effect movement of the flexible panels 112. Naturally, some embodiments may allow both the one or more panel motors 114 and/or one or more panel actuators 116 to move, thereby pivoting or otherwise moving the flexible panels 112. Such movement can also ensure that the one or more stretch-assistance armatures 104 are able to assist a user in moving their extremities among different planes of motion.

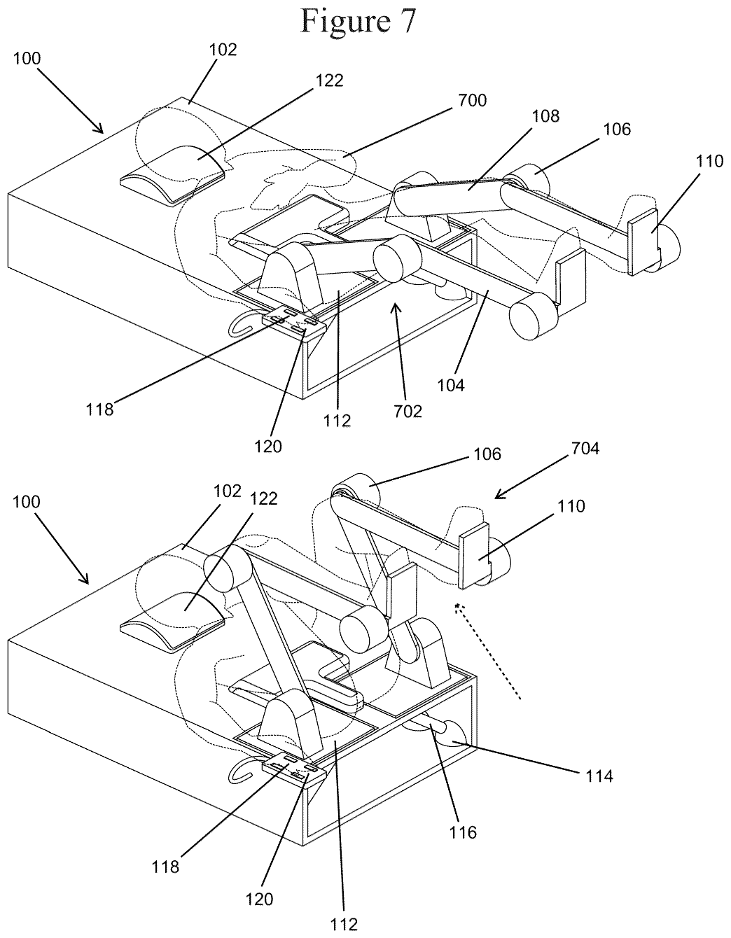

FIG. 7 is a perspective view of a stretching machine showing two stages of operation, in accordance with an embodiment of the invention. In some embodiments the device to aid in stretching 100 is comprised of: a base 102; and one or more stretch-assistance armatures 104 extending from the base 102 wherein the one or more stretch-assistance armatures 104 are comprised of one or more motorized joints 106, one or more pylons 108, and one or more user-securing fastenings 110. Depending on the embodiment, the base 102 may also be comprised of one or more flexible panels 112 located proximate to an end of the base 102 where such panels may be connected to the base via panel motors 114 and/or panel actuators 116 configured to allow them to rotate and/or translate in at least one direction. Depending on the embodiment, the device 100 may be further comprised of control unit 118 which may be further comprised of a computer processor, computer memory, and/or control device 120 wherein the computer memory is configured to store one or more programs which may be stretching routines, and the computer processor is configured to control the stretch-assistance armatures to guide a user 700 through such programs. The control device 120, which may be integrated into the base 102 and/or communicably coupled via a network, may be configured to permit a user 700 to control the device. Depending on the embodiment, the base 102 may be further comprised of one or more cushions 122 to support a user 700 that is utilizing the device.

FIG. 7 further demonstrates a user 700, indicated by a dashed lined human figure, moving through a stretch exercise as demonstrated in a first position 702, wherein the stretch-assistance armatures 104 then activate one of their motorized joints 106 thereby shrinking the angle between the two depicted pylons 108, indicated by the dashed arrow, and assisting the user 700 with bending their knees as shown in the second position 704. As can also be seen, the user 700 is operating the control device 120 to instruct the device to aid in stretching 100 to assist them in performing the motion.

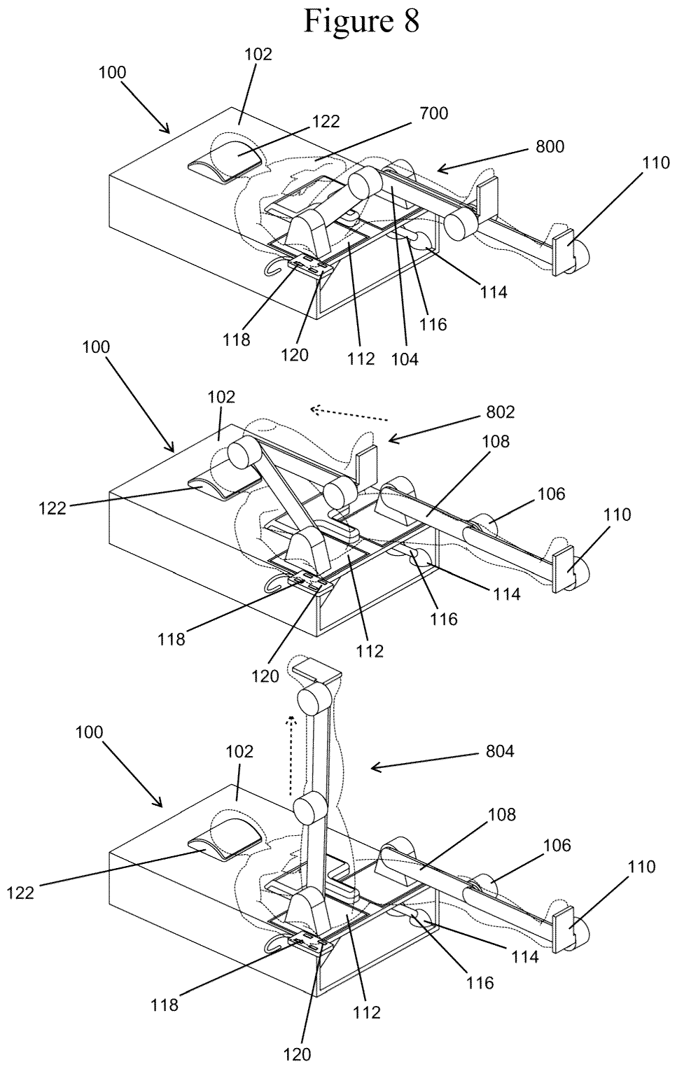

FIG. 8 is a perspective view of a stretching machine showing three stages of operation, in accordance with an embodiment of the invention. In some embodiments the device to aid in stretching 100 is comprised of: a base 102; and one or more stretch-assistance armatures 104 extending from the base 102 wherein the one or more stretch-assistance armatures 104 are comprised of one or more motorized joints 106, one or more pylons 108, and one or more user-securing fastenings 110. Depending on the embodiment, the base 102 may also be comprised of one or more flexible panels 112 located proximate to an end of the base 102 where such panels may be connected to the base via panel motors 114 and/or panel actuators 116 configured to allow them to rotate and/or translate in at least one direction. Depending on the embodiment, the device 100 may be further comprised of control unit 118 which may be further comprised of a computer processor, computer memory, and/or control device 120 wherein the computer memory is configured to store one or more programs which may be stretching routines, and the computer processor is configured to control the stretch-assistance armatures to guide a user 700 through such programs. The control device 120, which may be integrated into the base 102 and/or communicably coupled via a network, may be configured to permit a user 700 to control the device. Depending on the embodiment, the base 102 may be further comprised of one or more cushions 122 to support a user 700 that is utilizing the device.

FIG. 8 further demonstrates a user 700, indicated by a dashed lined human figure, moving through a stretch exercise as demonstrated in a first position 800, wherein the stretch-assistance armatures 104 then activate one of their motorized joints 106 thereby shrinking the angle between the two depicted pylons 108 and assisting the user 700 with bending their knees as shown in the second position 802 and the motion is indicated by the dashed arrow. Then the motorized joint 106 then once more rotates the depicted pylons 108 such that the user's 700 leg is extended by widening the angle between the depicted pylons 108 as indicated by the dashed arrow, resulting in a third position 804. As can also be seen, the user 700 is operating the control device 120 to instruct the device to aid in stretching 100 to assist them in performing the motion.

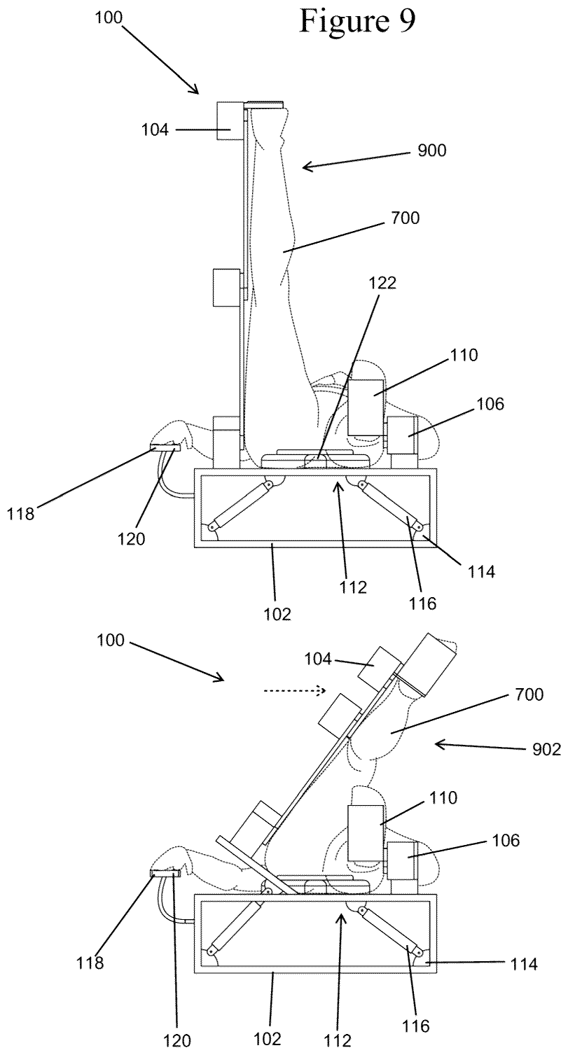

FIG. 9 is a rear view of a stretching machine showing the motion of flexible panels 112, in accordance with an embodiment of the invention. In some embodiments the device to aid in stretching 100 is comprised of: a base 102; and one or more stretch-assistance armatures 104 extending from the base 102 wherein the one or more stretch-assistance armatures 104 are comprised of one or more motorized joints 106, one or more pylons 108, and one or more user-securing fastenings 110. Depending on the embodiment, the base 102 may also be comprised of one or more flexible panels 112 located proximate to an end of the base 102 where such panels may be connected to the base via panel motors 114 and/or panel actuators 116 configured to allow them to rotate and/or translate in at least one direction. Depending on the embodiment, the device 100 may be further comprised of control unit 118 which may be further comprised of a computer processor, computer memory, and/or control device 120 wherein the computer memory is configured to store one or more programs which may be stretching routines, and the computer processor is configured to control the stretch-assistance armatures to guide a user 700 through such programs. The control device 120, which may be integrated into the base 102 and/or communicably coupled via a network, may be configured to permit a user 700 to control the device. Depending on the embodiment, the base 102 may be further comprised of one or more cushions 122 to support a user 700, indicated by a dashed lined human figure, that is utilizing the device.

As demonstrated in FIG. 9, the flexible panels 112 can also assist in stretching; as shown in this figure the one or more panel actuators 116 rotates the one of the flexible panels 112 from a rest position 900 to a crossed position 902 as indicated by the dashed arrow. The foregoing motion allows a user 700 to cross their leg over their body, as shown. As can also be seen, the user 700, indicated by a dashed lined human figure, is operating the control device 120 to instruct the device to aid in stretching 100 to assist them in performing the motion.

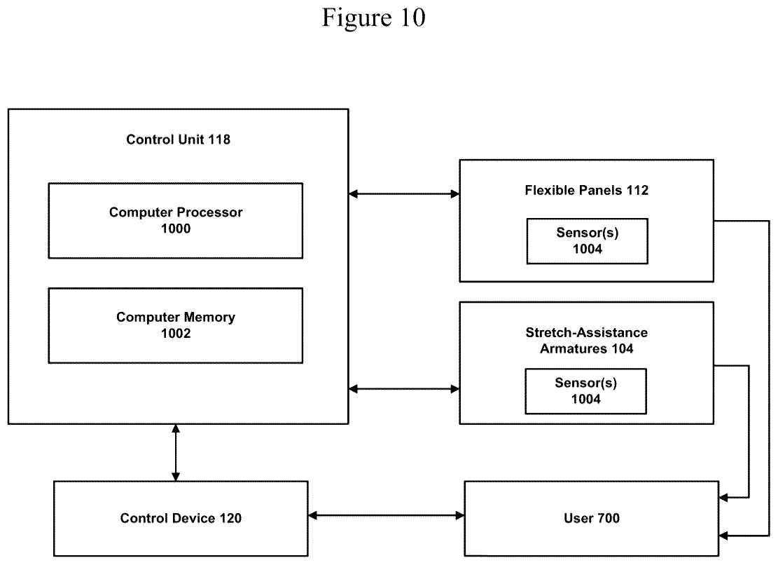

FIG. 10 is a system diagram showing the interaction between the control unit and the rest of the features of the invention, in accordance with an embodiment of the invention. In some embodiments, the stretching device is controlled by a control unit 118 which is further comprised of a control device 120, which may be, depending on the embodiment, a hand-held terminal that may or may not be wired to the stretching device and is communicably linked thereto. Depending on the embodiment, the control device 120 may be a user-input with a variety of means to send instructions to the control unit 118, and may allow the user 700 to control the one or more stretch-assistance armatures and/or one or more flexible panels directly, and/or by instructing them to perform certain movements of stretching routines. The control unit 118 may then be further comprised of a computer processor 1000 and a computer memory 1002, which are configured to control the one or more stretch-assistance armatures 104 and/or one or more flexible panels 112. Additionally, such control may be granular, allowing control of specific of the one or more stretch-assistance armatures 104 and/or one or more flexible panels 112. Depending on the embodiment, the one or more stretch-assistance armatures 104 and/or one or more flexible panels 112 may be further comprised of one or more sensors 1004, which may be configured to send information back to the control unit 118, which may be configured to provide a display or other means of feedback to a user 700, such as by sending it to a device with a display. The one or more sensors 1004 may be configured to detect information such as, but not limited to, resistance by a user 700, force being exerted by a user 700, displacement of the one or more stretch-assistance armatures 104 and/or one or more flexible panels 112 and/or angle of rotation of the one or more stretch-assistance armatures 104 and/or one or more flexible panels 112.

Depending on the embodiment, the device 100 may be further comprised of control unit 118 which may be further comprised of a computer processor 1000, computer memory 1002, and/or control device 120 wherein the computer memory 1002 is configured to store one or more programs which may be stretching routines, and the computer processor 1000 is configured to control the stretch-assistance armatures to guide a user 700 through such programs which is facilitated by the one or more stretch-assistance armatures 104 and/or one or more flexible panels 112. The control device 120, which may be integrated into the base 102 and/or communicably coupled via a network, may be configured to permit a user 700 to control the device 100.

Accordingly, the scope of the invention is not limited by the disclosure of these preferred and alternate embodiments. Instead, the invention should be determined by reference to the claims that follow.

What is claimed is:

1. A device to aid in stretching, the device comprising:
a base; and
one or more stretch-assistance armatures extending from the base wherein the one or more stretch-assistance armatures are comprised of one or more motorized joints and one or more user-securing fastenings.

2. The device of claim 1, wherein the base is further comprised of one or more flexible panels.

3. The device of claim 2, wherein the one or more flexible panels are configured with a motor configured to move the flexible panels in at least one plane of motion.

4. The device of claim 3, wherein the one or more flexible panels are comprised of ductile material configured to deform relative to the contour of a user's body.

5. The device of claim 1, wherein the one or more stretch-assistance armatures are further comprised of one or more user-supports wherein one of the user-supports is positioned at an end of the stretch-assistance armature distal relative to the base.

6. The device of claim 1, wherein the base is contoured on an upward-facing side and such contouring is substantially formed to accommodate a human back.

7. The device of claim 1, wherein the motorized joints of the one or more stretch-assistance armatures are configured to rotate a portion of the stretch-assistance armature.

8. The device of claim 1, wherein the device is further comprised of a control terminal configured to receive inputs from a user.

9. The device of claim 8, wherein the control terminal is configured to allow the user to control the one or more stretch-assistance armatures.

10. The device of claim 1, the device further comprising a computer processor and computer memory wherein the computer processor is configured to control the one or more stretch-assistance armatures and the computer memory is configured to store at least one stretching program.

11. The device of claim 10, wherein the user is able to select from the at least one stretching programs in the computer memory and the computer processor is configured to control the one or more stretch-assistance armatures through the selected program.

12. The device of claim 11, wherein the computer processor is further configured to activate the motorized joints of the one or more stretch-assistance armatures based on the at least one stretching program stored in the computer memory.

13. The device of claim 12, wherein the motorized joints are configured to only utilize certain amounts of force when operating and the computer processor is further configured to modify the stretching program it is running based on resistance by a user.

14. The device of claim 10, wherein the computer processor is communicably linked to a communications device configured to connect to a separate device through a network and the computer processor is further configured to receive instructions from the separate device.

15. The device of claim 1, wherein at least one of the one or more user-securing fastenings is a stirrup configured to receive a user's foot.

16. The device of claim 1, wherein at least one of the one or more user-securing fastenings is a length of flexible material configured to be wrapped around a user's leg and then fastened to itself.

17. The device of claim 12, wherein the stretching program is comprised of a plurality of movements of the one or more stretch-assistance armatures.

18. The device of claim 7, wherein the motors are limited in the force they can exert to be less than that of a user.

19. The device of claim 7, wherein the stretch-assistance armatures are further comprised of one or more sensors configured to detect resistance exerted by a user and are further configured to appropriately adjust their force if resistance is detected.

20. A device to aid in stretching, the device comprising:
a base comprised of
at least two flexible panels wherein each of the flexible panels is comprised of at least one rotation motor and the flexible panels are positioned at a first end of the base;
at least two stretch-assistance armatures extending from the base wherein the at least two stretch-assistance armatures are each comprised of one or more motorized joints and one or more user-securing fastenings wherein the at least two stretch-assistance armatures are positioned at the first end of the base and the motorized joints are further configured to be limited in their rotational force to be less than that a user can exert;
a computer memory configured to store at least one stretching program; and
a computer processor configured to operate the at least two flexible panels and at least two stretch-assistance armatures based on the at least one stretching program.
